(19) United States
(12) Patent Application Publication
(10) Pub. No.: US 2023/0115283 A1
(43) Pub. Date: Apr. 13, 2023

(54) THREE-LEVEL GRID MULTI-SCALE FINITE ELEMENT METHOD FOR SIMULATING GROUNDWATER FLOW IN HETEROGENEOUS AQUIFERS

(71) Applicant: Hohai University, Nanjing (CN)

(72) Inventors: Yifan Xie, Nanjing (CN); Yipeng Zeng, Nanjing (CN); Zhenze Xie, Nanjing (CN); Chunhui Lu, Nanjing (CN); Yu Ye, Nanjing (CN); Teng Xu, Nanjing (CN); Jie Yang, Nanjing (CN)

(21) Appl. No.: 17/936,367

(22) Filed: Sep. 28, 2022

(30) Foreign Application Priority Data
Oct. 8, 2021 (CN) 202111170398.X

(51) Int. Cl. G06F 30/23

(52) U.S. Cl. CPC G06F 30/23; G06F 2113/08

(57) ABSTRACT

A three-level grid multi-scale finite element method for simulating groundwater flow in heterogeneous aquifers is proposed in present disclosure. The three-level grid refers to dividing the study region into coarse grid elements, then dividing each coarse grid element into medium grid elements, and finally dividing each medium grid element into fine grid elements, thereby improving the coarse-scale basis function construction method of the multi-scale finite element method. The new method of constructing a coarse-scale basis function by using the multi-scale finite element method itself instead of the finite element method is provided, constructing medium-scale basis functions on local medium grid elements, and using the medium-scale basis functions to construct a coarse-scale basis function in each coarse element, which can significantly improve the construction efficiency of the coarse-scale basis function.

### CROSS-REFERENCE TO RELATED APPLICATIONS

This application claims the benefit and priority of Chinese Patent Application Number 202111170398.X, filed on Oct. 8, 2021, the disclosures of which are incorporated herein by reference in their entireties.

### TECHNICAL FIELD

The present disclosure relates to the technical field of hydraulics, in particular to a three-level grid multi-scale finite element method for simulating groundwater flow in heterogeneous aquifers.

### BACKGROUND

The finite element method is one of the powerful and effective numerical methods to solve groundwater problems. The finite element method not only has high accuracy, but also can adapt to various complex boundary conditions, which is an effective modern engineering calculation method. However, when traditional numerical methods such as finite element method are used to solve the groundwater problem with strong heterogeneity, fine division is required to ensure that the hydraulic conductivity coefficient in the grid element is approximately constant, which leads to too many unknown items and causes a large amount of computational consumption. When simulating groundwater problems with complex characteristics such as time-space large-scale and non-linearity, traditional numerical methods such as finite element method need huge computational cost, even if existing computers are used to solve them.

The multi-scale finite element method is a new type of groundwater numerical simulation method. Its basic principle is to form a coarse-scale basis function by constructing a differential operator satisfying the local ellipsoid on the coarse grid. This basis function can effectively obtain the macro characteristics of the waterhead, so as to improve the scale and reduce the computational consumption required for the simulation. However, the traditional multi-scale finite element method still needs a large amount of computation to construct the basis function when simulating the large-scale and high computational cost groundwater problems. With the development of economy and society, the time-space scale and simulation accuracy of groundwater problems in China are growing with each passing day. The low construction efficiency of multi-scale finite element method basis function will limit its development and application in the field of hydrogeology.

In view of the limitations of the above-mentioned traditional finite element method and traditional multi-scale finite element method, the research of the new three-level grid multi-scale finite element algorithm of the present disclosure has important theoretical and practical significance.

### SUMMARY

The object of the present disclosure is to overcome the deficiency of the method mentioned in background, and the present disclosure discloses a three-level grid multi-scale finite element method for simulating groundwater flow in heterogeneous aquifers. The method improves the construction efficiency of the coarse-scale basis function by improving the division method of the coarse grid and construction method of coarse-scale basis function, which can greatly improve the calculation speed of large-scale groundwater flow movement, and further improves the calculation accuracy by using the over-sampling technology.

The technical solution: A three-level grid multi-scale finite element method for simulating groundwater flow in heterogeneous aquifers provided by the present disclosure, including the following steps:

S1, determining a groundwater flow equation and a solution condition according to a groundwater flow problem that needs to be solved, determining a scale of coarse grid elements, and dividing a study region into several coarse grid elements, wherein vertices of coarse grid are coarse-scale nodes;

S2, determining a scale of the medium grid elements, dividing the coarse grid elements into several medium grid elements, wherein vertices of the medium grid are medium-scale nodes; determining a scale of fine grid elements, dividing the medium grid elements into several fine grid elements, and the vertices of fine grid are fine-scale nodes;

S3, on each of the medium grid elements within each of the coarse grid elements, considering a reduced elliptic problem with the medium-scale basis function as an unknown term, wherein the reduced elliptic problem is adapted according to boundary conditions of the medium-scale basis function; as to each of the medium grid elements, taking each of the medium grid elements as a problem area, applying the Galerkin method to conduct calculus of variations on the problem, using the fine grid element as a minimum sub-element, applying the finite element method to obtain values of the medium-scale basis function on all the fine-scale nodes in the medium grid elements, to complete a construction of the medium-scale basis function;

S4, on each of the coarse grid elements in the study region, considering the reduced elliptic problem with the coarse-scale basis function as an unknown term, wherein the reduced elliptic problem is adapted according to boundary conditions of the coarse-scale basis function; as to each of the coarse-scale elements, taking each of the coarse-scale elements as a problem area, applying the Galerkin method to conduct calculus of variations on the problem, discretizing the problem to each of medium grid elements in each of the coarse grid elements, and further discretizing the problem to each of fine grid elements of each of medium grid elements in each of the coarse grid elements by using the medium-scale basis function obtained in S3, applying the multi-scale finite element method to obtain values of the coarse-scale basis functions of all nodes in the coarse grid elements;

S5, based on the groundwater flow problem and coarse grid generation in S1, applying the multi-scale finite element method to form a stiffness matrix of the coarse grid elements of the waterhead on each of the coarse grid elements according to the coarse-scale basis function obtained in S4, and obtaining a total stiffness matrix of the waterhead by adding;

S6, calculating a right hand item to form an equation group according to the boundary conditions and a source-sink term of the study region;

S7, using an improved square root method to solve the equation group, so as to obtain a value of the waterhead of each node in the study region.

Wherein, in S1, the study region is divided by standard right triangle elements to form the coarse grid elements.

Further, in S2, the coarse grid elements are divided based on the standard right triangle elements to form medium grid elements; the medium grid elements are divided based on the standard right triangle elements to form the fine grid elements.

Further, the method includes S4.1 over-sampling technique, enlarging each coarse grid element in S1 into a temporary coarse grid element, adding nodes on the basis of the medium-scale nodes and fine-scale nodes of the original coarse grid obtained in S2 to divide the temporary coarse grid element; then applying S3 and S4 to construct a temporary coarse-scale basis function on the temporary coarse grid elements, and determining a over-sampling coefficient by using vertex values of the coarse-scale basis function of the original coarse grid; finally, obtaining the coarse-scale basis function of the original grid directly by using the temporary coarse-scale basis function and the over-sampling coefficient.

Further, the coarse-scale basis function obtained in S4.1 is used in S5.

Further, in S6, a value of the source-sink term takes an average value of the source-sink term of all the fine grid elements in the coarse grid elements.

The advantageous effects compared with the prior art are as follows:

1. The present disclosure greatly improves the construction efficiency of the basis function on each coarse grid element in the multi-scale finite element method, and improves the calculation efficiency of groundwater flow in heterogeneous media;

2. By dividing the study region into coarse, medium and fine grids, the present disclosure makes the element division more flexible and enhances the anti-distortion ability of the element;

3. When the total number of elements is the same, the calculation accuracy of the present disclosure is close to that of the traditional multi-scale finite element method and the calculation time is greatly reduced;

4. The present disclosure further improves the calculation accuracy of the waterhead in the present disclosure by using the over-sampling technology;

5. The present disclosure can effectively solve the steady flow and unsteady flow problems of groundwater in heterogeneous aquifers, such as the continuous medium problem of two-dimensional steady flow, the gradually varied medium problem of two-dimensional unsteady flow, the two-dimensional phreatic flow model, etc., the principle is simple, efficient and accurate;

6. When the large-scale, long-time and other large calculation problems are solved by the present disclosure, the advantage of calculation efficiency is more obvious.

### BRIEF DESCRIPTION OF THE DRAWINGS

FIG. 1 is a diagram of the study region division of the method provided by the present disclosure;

FIG. 2 is a diagram of a coarse grid element division of the method provided by the present disclosure;

FIG. 3 is an absolute error diagram of waterhead of each numerical at y=10 m in the model of the embodiment of the present disclosure;

FIG. 4 is a time chart for calculating MSFEM and TMSFEM according to the present disclosure;

FIG. 5 is a graph showing the calculation absolute error when MSFEM and TMSFEM are divided into different element numbers according to the present disclosure.

### DETAILED DESCRIPTION OF THE EMBODIMENTS

The technical solution of the present disclosure will be further described below in combination with the drawings and embodiments.

A three-level grid multi-scale finite element method for simulating groundwater flow in heterogeneous aquifers, including the following steps:

S1, determining a groundwater flow equation and a solution condition according to a groundwater flow problem that needs to be solved, determining a scale of coarse grid elements, and dividing a study region into several coarse grid elements, wherein vertices of coarse grid are coarse-scale nodes. The study region is divided by standard right triangle elements to form the coarse grid elements.

S2, determining a scale of the medium grid elements, dividing the coarse grid elements into several medium grid elements, wherein vertices of the medium grid are medium-scale nodes; determining a scale of fine grid elements, dividing the medium grid elements into several fine grid elements, wherein the vertices of fine grid are fine-scale nodes. The coarse grid elements are divided based on the standard right triangle elements to form medium grid elements; the medium grid elements are divided based on the standard right triangle elements to form the fine grid elements.

S3, on each of the medium grid elements within each of the coarse grid elements, considering a reduced elliptic problem with the medium-scale basis function as an unknown term, wherein the reduced elliptic problem is adapted according to boundary conditions of the medium-scale basis function; as to each of the medium grid elements, taking each of the medium grid elements as a problem area, applying the Galerkin method to conduct calculus of variations on the problem, using the fine grid element as a minimum sub-element, applying the finite element method to obtain values of the medium-scale basis function on all the fine-scale nodes in the medium grid elements, to complete a construction of the medium-scale basis function.

S4, on each of the coarse grid elements in the study region, considering the reduced elliptic problem with the coarse-scale basis function as an unknown term, wherein the reduced elliptic problem is adapted according to boundary conditions of the coarse-scale basis function; as to each of the coarse-scale elements, taking each of the coarse-scale elements as a problem area, applying the Galerkin method to conduct calculus of variations on the problem, discretizing the problem to each of medium grid elements in each of the coarse grid elements, and further discretizing the problem to each of fine grid elements of each of medium grid elements in each of the coarse grid elements by using the medium-scale basis function obtained in S3, applying the multi-scale finite element method to obtain values of the coarse-scale basis functions of all nodes in the coarse grid elements.

S4.1 using over-sampling technique to increase the accuracy of the solution, enlarging each coarse grid element in S1 into a temporary coarse grid element, adding nodes on the basis of the medium-scale nodes and the fine-scale nodes of the original coarse grid obtained in S2 to divide the temporary coarse grid element; then applying S3 and S4 to construct a temporary coarse-scale basis function on the temporary coarse grid elements, and determining a over-sampling coefficient by using a vertex value of the coarse-scale basis function of the original coarse grid; finally, obtaining the coarse-scale basis function of the original grid directly by using the temporary coarse-scale basis function and the over-sampling coefficient.

S5, based on the groundwater flow problem and the coarse grid division in S1, applying the multi-scale finite element method to form a stiffness matrix of the coarse grid elements of the waterhead on each of the coarse grid elements according to the coarse-scale basis function obtained in S4.1, and obtaining a total stiffness matrix of the waterhead by adding all of the stiffness matrices of the coarse grid elements.

S6, calculating a right hand item to form an equation group according to the boundary conditions and a source-sink term of the study region. The value of the source-sink term takes an average value of the source-sink term of all the fine grid elements in the coarse grid elements.

S7, using an improved square root method to solve the equation group, so as to obtain the value of the waterhead of each node in the study region.

The following illustrates the detail implementation process of the present disclosure:

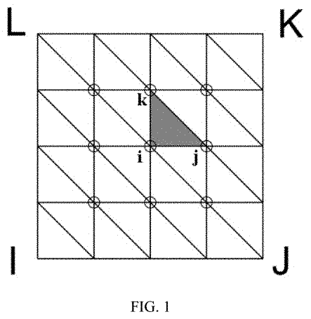

As described in S1, the study region Q is given as an example, which is a rectangular area with vertices IJKL respectively. According to the black solid line in FIG. 1, the study region IJKL can be divided into several coarse grid elements. Let one of the coarse grid elements be Δᵢⱼₖ.

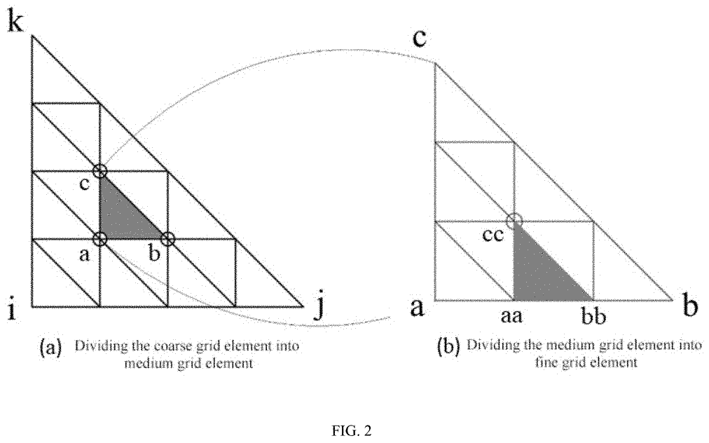

As described in S2, the coarse grid element Δᵢⱼₖ is divided into medium grid element Δ_{abc} according to the triangular division method in the left figure of FIG. 2, and the medium grid element Δ_{abc} is divided into fine grid elements Δ_{aabbcc} according to the division method in the right figure of FIG. 2.

As described in S3, a medium-scale basis function is constructed. A medium-scale basis function φ is constructed by solving reduced elliptic equations on the medium grid elements Δ_{abc}. Taking the fine grid element as the minimum element to solve the construction equation can obtain the values of all nodes of the medium-scale basis function in the medium grid element Δ_{abc}, the detail as follows:

Taking the above medium-scale basis function φₐ on the medium grid elements Δ_{abc} as an example, the reduced elliptic equation is as follows:

∇·K(x,y)∇φₐ=0,(x,y)∈Δ_{abc} (1)

Wherein, K is the hydraulic conductivity coefficient tensor; φₐ is the medium-scale basis function at the vertex a of the medium grid element. The boundary conditions of φₐ can be determined by the linear and oscillatory boundary conditions of the basis function.

Applying Galerkin's variational principles to equation (1), it can get:

J_{MM}_{_{τ}}=∫∫_{Δ}_{_{abc}}K(x,y)∇φa·∇N_{MM}_{_{τ}}dxdy=0,τ=1,2, . . . ,pp (2)

Wherein, N_{MM}_{_{τ}}is the linear basis function value at the unknown node MM_{τ}; pp is the total number of unknown nodes.

According to MSFEM theory, the medium-scale basis function φₐ at each fine grid element Δ_{aabbcc} in the medium grid elements Δ_{abc} can be expressed as:

φₐ(x,Y)=φₐ(aa)Nₐₐ+φₐ(bb)N_{bb}+φₐ(cc)N_{cc},(x,y)∈Δ_{aabbcc} (3)

Wherein, Nₐₐ, N_{bb} and N_{cc} are the finite element linear basis functions at the three vertices aa, bb and cc of the fine grid element Δ_{aabbcc} respectively.

Take equation (3) into equation (2) and discretize it into fine grid elements. After simplification and transposition of terms, the equation A_{1φa}=f₁ can be obtained. In the equation: A₁ is the symmetric positive definite stiffness matrix on the medium grid; f₁ is the right hand item. The solution can obtain the values of all nodes of the medium-scale basis function φₐ with respect to the medium grid Δ_{abc}. The solution processes of φ_{b} and φ_{c} are similar.

As described in S4, a coarse-scale basis function is constructed. Taking the medium grid element with fine grid elements as the minimum element, the multi-scale finite element method is applied to solve the construction equation, and the values of all nodes of the coarse-scale basis function in the coarse grid element Δᵢⱼₖ can be obtained.

Taking the above coarse-scale basis function Ψᵢ with respect to the coarse grid element Δᵢⱼₖ as an example, the reduced elliptic equation is as follows:

∇·K(x,y)∇Ψᵢ=0,(x,y)∈Δᵢⱼₖ (4)

Wherein, K is the hydraulic conductivity coefficient tensor; Ψᵢ is the coarse-scale basis function of point i. The boundary conditions of Ψᵢ can be determined by the linear and oscillatory boundary conditions of the basis function.

Applying Galerkin's variational principles to equation (4), it can obtain:

Jₘ_{_{τ}}=Σ∫∫Δ_{abc}K(x,y)∇Ψᵢ·∇_{M}_{_{τ}}dxdy=0,τ=1,2, . . . ,p (5)

Wherein, φ_{M}_{_{τ}}, is the medium grid basis function at the unknown node M_{τ}; p is the total number of unknown nodes.

In each medium grid Δ_{abc}, Ψᵢ can be represented by a medium-scale basis function and Ψᵢ can be expressed as

Ψᵢ(x,Y)=Ψᵢ(a)φₐ+Ψᵢ(b)φ_{b}+Ψᵢ(c)φ_{c}(x,y)∈Δ_{abc} (6)

Wherein, φₐ, φ_{b} and φ_{c} are the medium-scale basis function values at three vertices a, b and c in the medium grid Δ_{abc}.

Take equation (6) into equation (5), and then discretize it into fine grid elements, and combine equation (3). After simplification and transposition of terms, the equation A₂Ψᵢ=f₂ can be obtained. Wherein: A₂ is the symmetric positive definite stiffness matrix on the coarse grid; f₂ is the right hand item. The solution can obtain the values of Ψᵢ at all nodes in the coarse grid Δᵢⱼₖ. The solution processes of Ψᵢ and Ψₖ are similar.

As described in S4.1, the over-sampling technique is applied. First, the original coarse grid element Δᵢⱼₖ is enlarged, and then temporary coarse-scale basis functions Φᵢ, Φⱼ and Φₖ are constructed on the enlarged element (over-sampling element). Finally, the original coarse-scale basis function is represented by the temporary basis function.

Ψᵢ=C₁₁Φᵢ+C₁₂Φⱼ+C₁₃Φₖ

Ψⱼ=C₂₁Φᵢ+C₂₂Φⱼ+C₂₃Φₖ

Ψₖ=C₃₁Φᵢ+C₃₂Φⱼ+C₃₃Φₖ (7)

Wherein, the over-sampling coefficient C_{αβ}, α, β=1,2,3 is a constant. Take Ψᵢ as an example, the C_{αβ} are satisfied the following conditions:

Ψᵢ(xᵢ,yᵢ)=C₁₁Φᵢ(xᵢ,yᵢ)+C₁₂Φⱼ(xᵢ,yᵢ)+C₁₃Φk(xᵢ,yᵢ)=1

Ψᵢ(xⱼ,yⱼ)=C₁₁Φᵢ(xⱼ,xⱼ)+C₁₂Φⱼ(xⱼ,yⱼ)+C₁₃Φₖ(xⱼ,yⱼ)=0

Ψᵢ(xₖ,yₖ)=C₁₁Φᵢ(xₖ,yₖ)+C₁₂Φⱼ(xₖ,yₖ)+C₁₃Φₖ(xₖ,yₖ)=0 (8)

S3 and S4 are applied to construct temporary coarse-scale basis functions Φᵢ, Φⱼ and Φₖ on the temporary coarse grid elements, and the value of the original coarse-scale basis function Ψᵢ is obtained by combining equation (8). The solution processes of Ψᵢ and Ψₖ are similar, here is not described in detail for brevity.

As described in S5 and S6, the equations on all coarse elements in the study region can be established together to obtain the total equation set on the waterhead. S7, the improved square root method is applied to solve total equation set, and the waterhead value of each node in the study region is obtained.

Wherein, in S2, the number of medium grid elements and fine grid elements is not limited to 16 and 9 shown in the figure, and can be flexibly adjusted according to actual demands.

The present disclosure will be further explained in combination with detail applications, and the abbreviations are as follows:

LFEM: finite element method;

LFEM-F: finite element method (fine division);

MSFEM-L: traditional multi-scale finite element method with linear boundary conditions;

MSFEM-O: traditional multi-scale finite element method with oscillatory boundary conditions;

TMSFEM-L: three-level grid multi-scale finite element method with linear boundary conditions;

TMSFEM-O: three-level grid multi-scale finite element method with oscillatory boundary conditions;

TMSFEM-OS: three-level grid multi-scale finite element method with over-sampling technique.

Embodiment 1: Applying to continuous variation model of two-dimensional steady flow

The two-dimensional groundwater steady flow equation is:

$$\frac{\partial }{\partial x} ( K \frac{\partial H}{\partial x} ) + \frac{\partial }{\partial y} ( K \frac{\partial H}{\partial y} ) = 0 , ( x , y ) ∈ Ω \qquad ( 9 )$$

Wherein, the study region Ω=[5 m, 15 m]×[5 m, 15 m]; the hydraulic conductivity coefficient is continuous variationK(x,y)=x²; the equation has an analytical solution H=3y²−x²+200; the dirichlet boundary condition are given by analytical solutions.

LFEM, LFEM-F, MSFEM-L, MSFEM-O, TMSFEM-L and TMSFEM-0 are used. By applying LFEM, MSFEM and TMSFEM, the study region are divided into 1800 coarse grid elements. By applying MSFEM, each coarse grid is directly divided into 36 fine grid elements; By applying TMSFEM, each coarse grid is divided into 9 medium grid elements firstly, and then each medium grid is divided into 4 fine grid elements. By applying LFEM-F, the study region is directly divided into 64800 fine grid elements which are the same as MSFEM and TMSFEM.

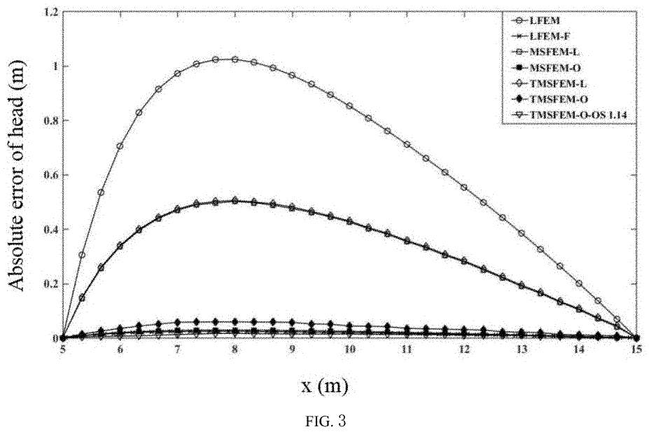

FIG. 3 shows the absolute error diagram of waterhead calculated by various numerical methods at y=10 m. It can be seen from the figure that the error of LFEM is the largest, and the waterhead accuracy of TMSFEM-L is very close to that of MSFEM-L and better than that of LFE. The errors of MSFEM-O, TMSFEM-O and LFEM-F are the smallest. Wherein the waterhead accuracy of TMSFEM-O is slightly lower than that of MSFEM-O, because TMSFEM uses algorithm of MSFEM to construct the basis function, and the accuracy of the basis function is slightly lower than that of MSFEM using LFEM-F, which slightly reduces the accuracy of solution. Moreover, by using the over-sampling technique, the calculation accuracy of TMSFEM can be significantly promoted, and the larger the amplification factor, the higher the accuracy. When the amplification factor of TMSFEM-O-OS is 1.14 times, the result is even better than that of LFEM-F, which indicates that TMSFEM can replace LFEM-F to some degree when simulating groundwater flow problems. It can be seen from the accuracy relationship of each method that TMSFEM can achieve similar effects to LFEM-F and MSFEM, and the calculation accuracy of TMSFEM and MSFEM can be significantly improved by using the oscillating boundary condition of the basis function. The results show that TMSFEM-O can better deal with the problem of heterogeneous groundwater. In addition, the calculation time of TMSFEM and TMSFEM-O-OS in this embodiment is 5 seconds and 6 seconds respectively, which can greatly reduce the calculation consumption compared with LFEM-F (14301 seconds).

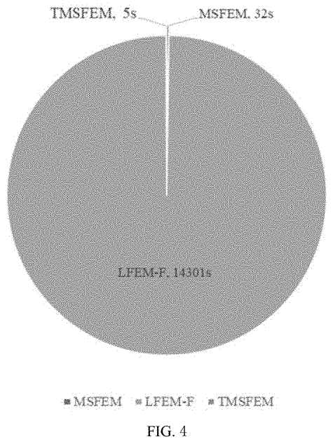

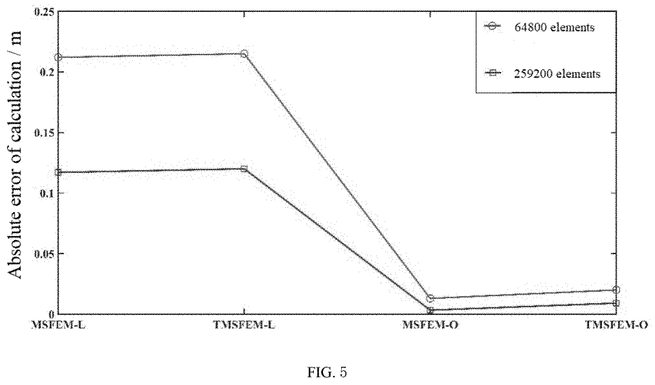

In addition, the study region can be divided into 3200 coarse grid elements by applying TMSFEM and MSFEM, and each coarse grid element is divided into 81 fine grid elements, that is, 259200 fine grid elements in total. FIG. 4 shows the calculation time of MSFEM and TMSFEM when the study region are divided into 64800 grid elements by MSFEM and TMSFEM respectively. When the study region is divided into 64800 elements, the CPU calculation time of TMSFEM is about 16% of that of MSFEM. FIG. 5 shows the calculation errors of the four methods when the study region are divided into 64800 grids and 259200 grid elements by the four methods. The results show that the calculation accuracy of MSFEM and TMSFEM is similar, and the calculation accuracy of the two methods under the oscillating boundary condition is much higher than that of the two methods under the linear boundary condition, which indicates that the calculation accuracy can be significantly improved by using the oscillating boundary condition for the basis function. The results show that compared with MSFEM, TMSFEM has higher computational efficiency with similar computational accuracy. When calculating large-scale problems, the efficiency advantage of TMSFEM will be more obvious.

Embodiment 2: Applying the method of the present disclosure to an alluvial plain study region in the North China Plain to solve the waterhead distribution of groundwater in the study region.

S1: There are rivers on the west and east sides of the study region. The rivers can be set as constant head boundary conditions. The waterhead of the river on the west side is higher, and the measured water level H is 10 m. The waterhead of the river on the east side is lower, and the measured water level H is 0 m. Let the waterhead in the north and south of the study region be the boundary which is the impermeable boundary, that is, the flow is 0. Let the southwest corner of the study region be the origin, and let the west-east direction and south-north direction be x axis, y axis, respectively. Then the study can be expressed as Ω=[0 m, 10000 m]×[0 m, 10000 m], and the governing equation is the steady flow equation which can be described by equation (9).

Based on the hydrogeological survey data, the parameters of the above equation are obtained. Wherein the aquifer thickness is 10 m. The infiltration capacity of the aquifer medium gradually increases from west to east, thus the hydraulic conductivity coefficient slowly increases from 1 m/d to 251 m/d from west to east, i.e. K(x,y)=(40+x)/40 m/d. Since the rainfall recharge is little in the study region, it can be ignored and the source-sink term can be set as W=0. So far, the above setting of the definite solution conditions of the problem is completed.

Each boundary of the study region is divided into 30 equal parts by applying TMSFEM, and the coarse grid elements can be obtained by connecting the aliquot point. That is, 1800 coarse grid elements are obtained in total by dividing. The method of division is similar to that in FIG. 1.

S2: Based on TMSFEM, each coarse grid element is divided into 9 medium grid elements, and then each medium grid element is divided into 4 fine grid elements. Then, the total number of fine grid elements is 64800.

S3: The medium-scale basis function is constructed, the processes can be found in the relevant parts of equations (1) -(3).

S4: The coarse scale basis function is constructed, the processes can be found in the relevant parts of equations (4) -(6).

S4.1: Over-sampling technique, the processes can be found in the relevant parts of equations (7) -(8).

In this example, the hydraulic conductivity coefficient K(x,y)=(40+x)/40 m/d used in S3, S4 and S4.1 is obtained by hydrogeological investigation.

S5: Applying Galerkin's variational principles into equation (9), and discretizing it to each coarse grid element Δᵢⱼₖ by using coarse-scale basis function Ψᵢ.

$$\int {\int }_{Ω} [ \frac{\partial }{\partial x} ( K \frac{\partial H}{\partial x} ) + \frac{\partial }{\partial y} ( K \frac{\partial H}{\partial y} ) + W ] \cdot {Ψ}_{i} dxdy = 0 \qquad ( 10 )$$

According to the principle of multi-scale finite element method, the coarse-scale basis function Ψᵢ can be linearly expressed on each coarse grid element Δᵢⱼₖ as follows:

H(x,y)=HᵢΨᵢ(x,y)+HⱼTⱼ(x,y)+HₖΨₖ(x,y) (11)

wherein Hᵢ, Hⱼ and Hₖ are the values of waterhead at the verteices i, j and k, respectively.

With the coarse-scale basis function Ψᵢ, Ψⱼ and Ψₖ obtained in S4, combining equations (11), (6) and (3), respectively, discretizing equation (10) into coarse-scale, medium-scale and fine-scale grid elements, sequentially. Then, the detail expression of equation (10) can be obtained.

The element stiffness matrix of the coarse grid element is formed by the coefficients of the unknown terms Hᵢ, Hⱼ and Hₖ which is the waterhead unknowns in the components on each coarse grid element Δᵢⱼₖ in equation (10). Then, the total stiffness matrix of the study region can be obtained by combining the coarse element stiffness matrix on every coarse grid element.

S6: According the boundary conditions and source-sink terms of the problem mentioned in S1, the known terms of them can be obtained by substituting them into the components of equation (10) on each coarse grid element Δᵢⱼₖ. These known terms can be moved to the right side as the right hand item. Combining with all the right hand items and the total stiffness matrix, the total equation system of the groundwater flow problem are formed on the study region.

S7: The waterhead value of the study region can be obtained by solving the total equations by Cholesky decomposition method.

Simulation results: In order to show the advantages of the present disclosure, traditional methods are used for comparison. Wherein the definite solution condition is shown in S1. Since there is no analytical solution in this embodiment, the LFEM-F numerical solution, which is finely divides the study region into 64800 grid elements, is taken as the “standard solution”. The comparison method MSFEM is used to divide the study region into 1800 coarse grid elements, and the comparison method LFEM is used to divide the study region into 1800 elements, MSFEM is used to divide each coarse grid element into 36 fine grid elements, to obtain 64800 elements that are the same as the method TMSFEM does.

By comparing the distribution of each waterhead of each numerical method at the y=6000 m section, it can be seen that the solution of LFEM is farthest from the “standard solution” of LFEM-F, which shows that the error of LFEM is the largest. TMSFEM-L and MSFEM-L have the same basis functions, so their waterhead values are very close, which are slightly better than the results of LFEM, but there is still a distance from the result of “standard solution” of LFEM-F. For TMSFEM-O and MSFEM-O, the results of both are close to the result of “standard solution” of LFEM-F, and the results of MSFEM-O are slightly better than those of TMSFEM-O. When TMSFEM-O adopts the over-sampling technique with the amplification factor of 1.1, its results can surpass MSFEM-O. The result show that for the two-dimensional steady groundwater flow problem with gradually varied hydraulic conductivity coefficient, TMSFEM and MSFEM can solve the distribution of waterhead with high accuracy, and the calculation accuracy of both is close to the result of the “standard solution” of LFEM-F, and the calculation accuracy can be significantly improved when the basis function adopts the oscillating boundary condition. After using the over-sampling technique, the calculation accuracy of TMSFEM can be further improved.

What is claimed is:

1. A three-level grid multi-scale finite element method for simulating groundwater flow in heterogeneous aquifers, comprising the following steps:
S1, determining a groundwater flow equation and a solution condition according to a groundwater flow problem that needs to be solved, determining a scale of coarse grid elements, and dividing a study region into several coarse grid elements, wherein vertices of coarse grid are defined as coarse-scale nodes;
S2, determining a scale of the medium grid elements, dividing the coarse grid elements into several medium grid elements, wherein vertices of the medium grid are medium-scale nodes; determining a scale of fine grid elements, dividing the medium grid elements into several fine grid elements, and the vertices of fine grid are fine-scale nodes;
S3, on each of the medium grid elements within each of the coarse grid elements, considering a reduced elliptic problem with the medium-scale basis function as an unknown term, wherein the reduced elliptic problem is adapted according to boundary conditions of the medium-scale basis function; as to each of the medium grid elements, taking each of the medium grid elements as a problem area, applying the Galerkin method to conduct calculus of variations on the reduced elliptic problem, defining the fine grid element as a minimum sub-element, applying the finite element method to obtain values of the medium-scale basis function on all the fine-scale nodes in the medium grid elements, to complete a construction of the medium-scale basis function;
S4, on each of the coarse grid elements in the study region, considering the reduced elliptic problem with the coarse-scale basis function as an unknown term, wherein the reduced elliptic problem is adapted according to boundary conditions of the coarse-scale basis function; as to each of the coarse-scale elements, taking each of the coarse-scale elements as a problem area, applying the Galerkin method to conduct calculus of variations on the problem, discretizing the problem to each of medium grid elements in each of the coarse grid elements, and further discretizing the problem to each of fine grid elements of each of medium grid elements in each of the coarse grid elements by using the medium-scale basis function obtained in S3, applying the multi-scale finite element method to obtain values of the coarse-scale basis functions of all nodes in the coarse grid elements;
S5, based on the groundwater flow problem and coarse grid generation in S1, applying the multi-scale finite element method to form a stiffness matrix of the coarse grid elements of the waterhead on each of the coarse grid elements according to the coarse-scale basis function obtained in S4, and obtaining a total stiffness matrix of the waterhead by adding all of the stiffness matrices of the coarse grid elements;
S6, calculating a right hand item to form an equation group according to the boundary conditions and a source-sink term of the study region;
S7, using an improved square root method to solve the equation group, so as to obtain a value of the waterhead of each node in the study region.

2. The three-level grid multi-scale finite element method for simulating groundwater flow in heterogeneous aquifers according to claim 1, wherein, in S1, the study region is divided by standard right triangle elements to form the coarse grid elements.

3. The three-level grid multi-scale finite element method for simulating groundwater flow in heterogeneous aquifers according to claim 1, wherein, in S2, the coarse grid elements are divided based on the standard right triangle elements to form medium grid elements; the medium grid elements are divided based on the standard right triangle elements to form the fine grid elements.

4. The three-level grid multi-scale finite element method for simulating groundwater flow in heterogeneous aquifers according to claim 1, wherein the method comprises S4.1 over-sampling, enlarging each coarse grid element in S1 into a temporary coarse grid element, adding nodes on the basis of the medium-scale nodes and fine-scale nodes of the original coarse grid obtained in S2 to divide the temporary coarse grid element; then applying S3 and S4 to construct a temporary coarse-scale basis function on the temporary coarse grid elements, and determining a over-sampling coefficient by using a vertex value of the coarse-scale basis function of the original coarse grid; finally, obtaining the coarse-scale basis function of the original grid directly by using the temporary coarse-scale basis function and the over-sampling coefficient.

5. The three-level grid multi-scale finite element method for simulating groundwater flow in heterogeneous aquifers according to claim 4, wherein the coarse-scale basis function obtained in S4.1 is used in S5.

6. The three-level grid multi-scale finite element method for simulating groundwater flow in heterogeneous aquifers according to claim 1, wherein, in S6, a value of the source-sink term takes an average value of the source-sink term of all the fine grid elements in the coarse grid elements.
